(19) United States
(12) Patent Application Publication
(10) Pub. No.: US 2014/0284326 A1
(43) Pub. Date: Sep. 25, 2014

(54) UTILITY BOX AND LID ASSEMBLY

(71) Applicant: VORTEX FACILITIES MANAGEMENT PTY LTD, Ringwood North, Victoria (AU)

(72) Inventors: Salvatore Macaluso, Ringwood North (AU); Jamie Andrew Zoch, Watsonia (AU); Luke Vincent Orton, Croydon (AU); Selasi Yaw Dorcoo, Brunswick (AU)

(21) Appl. No.: 14/355,468

(22) PCT Filed: Oct. 31, 2012
(86) PCT No.: PCT/AU2012/001327

§ 371 Date: Apr. 30, 2014

(30) Foreign Application Priority Data
Oct. 31, 2011 (AU) 2011904530
Feb. 4, 2012 (AU) 2012900409
Feb. 15, 2012 (AU) 2012900541
Mar. 2, 2012 (AU) 2012100235

(51) Int. Cl. H02G 3/08

(52) U.S. Cl. CPC H02G 3/081
USPC 220/3.3; 220/241

(57) ABSTRACT

A lid assembly, for a floor mounted utility box allowing data/electrical cable connections, including: a frame, a lid, and a flap, wherein the frame is mounted upon the utility box so that, it lies substantially flush with the floor. The lid including rear, front panels hingedly connected; the rear edge of the rear panel hingedly connected to the rear edge of the frame. The flap is hingedly connected to the front panel, so that when the lid is closed, at least the rear/front panels lay flat and substantially flush with the level of the floor. When opened, the lid bifolds about the hinged connection between the rear/front panels, causing the forward edge of the front panel slide towards the rear edge of the frame, so that when the lid is moved to its fully opened position, the rear/front panels substantially overlay one another in the vicinity of the rear of the frame.

### SUMMARY OF THE INVENTION

This invention concerns utility boxes of the type that are mounted in a floor and when closed, significantly sit flush with the level of the floor. These types of floor mounted utility boxes are used extensively throughout office buildings, particularly in meeting and conference rooms, and provide an array of data and power supply services.

### BACKGROUND

Electrical floor boxes are installed in many corporate offices to provide mobile device users (laptop, mobile phone etc) with easy access to power and data with conference/meetings rooms or at desks.

In the corporate world, correct usage of the floor box is secondary to the job functions of the users. Usually, users are in a hurry to get their mobile devices set up for a meeting or presentation and as a result are not consciously thinking about using the floor box correctly. Even if users applied conscious thought to the correct usage of the floor box, the current floor boxes are not user friendly. For example, to open any one of the current floor boxes requires the user to attempt to grab a piece of metal wire or plastic handle. In all cases, the metal wire or plastic handles are not easy to reach because of flawed design. If the user manages to get the floor box open and plugs in their electrical or data cables, they still have to perform a series of complicated steps in order to close the floor box correctly. The first step requires the user to guide his or her cables into the flap opening of the floor box. In most cases, this requires threading the cables through cable ties either on the underside of the lid of the floor box, or through specific ties at the designated exit point of the floor box. The user then has to hold the floor box lid open with one hand, push the back lid back with the other hand, whilst guiding the lid down so that all sides of the lid fit within the frame of the floor box. Done correctly, only the front flap exit point sticks up above the ground to allow the cables to exit the floor box. Together, the points described above (floor box is secondary to job function of corporate users, floor box is user unfriendly, users are not trained on correct usage of the floor box) results in a situation in which the current floor box design poses a major safety and liability risk. Its incorrect use doesn't allow the end user to safely plug-in or access electrical cables without the potential for electrocution. Current floor box designs do not close flush when cables are protruding from the sides and undesignated exit points. This problem creates an unsafe environment as it is a tripping hazard.

Furthermore when an electrical cable is allowed to exit from the side of a current floor box and the lid is closed shut, the lid acts as a guillotine and can damage the cables by either shearing or cutting the cable exposing the copper wires.

If the exposed wires come into contact with the internal part of the floor box which is metallic, it has the potential to make, the entire box electrically “live”. In turn, if the end user then attempts to connect or remove cables, touching either the exposed copper wires or any internal metallic surface may pose an electrocution hazard.

The Residual Current Device (RCD) is not 100% effective, and may fail to activate when a user receives an electric shock when they make contact with the exposed “live” copper wire or utility box.

In addition to the problems associated with the lid, there is also the problems associated with the size and shape of the utility box itself. In the past decade, there has been a substantial growth in the demand for high speed data services. The data cabling that is often used to provide the data service has increased in capacity accordingly to accommodate the greater bandwidth required to provide high speed data services to users in places like offices and conference/meeting rooms. This increase in cable capacity is has seen the specifications of the data cable increase accordingly. It is now becoming more common for business administrators and owners to install CAT 6, CAT 6A or even CAT 7 optical cabling.

CAT 6A data cables can transmit more data and transmit that data at least 10 times faster than its closest competitor. CAT 6A cable is able to achieve this as a result of having more copper wires, more shielding and better insulation built into the cable. However, this has resulted in the CAT 6A cable being stiff and needing a far greater bending radius than any of its predecessors. If the bend radius of CAT 6A is not accommodated, and the cable is forced to exceed its minimum bending radius, then a kink may result, and the kink in the cable significantly degrades the capacity and speed of data transmission of the CAT 6A cable and can also damage the insulation and shielding in the cable.

This is therefore causing significant problems. The floor boxes that are currently in the market were not designed to allow for the greater bending radius of CAT 6A or optical fiber CAT 7 cables. As a result, only a handful of floor boxes can fit CAT 6A. I say only a handful because certain floor boxes can be made to fit CAT 6A by bringing the steel frame for mounting the wall plates closer together to create more space behind the plates for cables to bend into. However, doing this makes the box unusable as ordinary power cables cannot be plugged into these floor boxes, thus severely limiting their use.

An aim of the present invention is to provide a utility box and lid assembly that maintains accessibility by providing sufficient distance between the faceplates of the connection ports, while providing sufficient clearance in space available for the data cabling and to minimize trip hazards and also to reduce the likelihood of there being shearing forces applied to the cable(s) by the lid itself as it closes.

### DISCLOSURE OF THE INVENTION

Accordingly the invention is a lid assembly for a floor mounted utility box of the type allowing the connection of a variety of data and/or electrical cables that when connected, extend out of the utility box. The said lid assembly including:
a frame,
a lid, and
a flap,
   wherein the frame is mounted upon the utility box and when it is mounted, it lies substantially flush with the level of the floor. The lid includes a rear panel and a front panel that are hingedly connected to each other. The rear edge of the rear panel is hingedly connected to the rear edge of the frame. The flap is hingedly connected to the forward edge of the front panel, so that when the lid is closed, at least the rear panel and the front panel lay flat and substantially flush with the level of the floor. When the lid is opened, the lid bifolds about the hinged connection between the rear and front panels, causing the forward edge of the front panel to slide towards the rear edge of the frame, so that when the lid is moved to its fully opened position, the rear and front panels substantially overlay one another in the vicinity of the rear of the frame.

Preferably the rear panel includes a handle that is located in the vicinity of the hinge between the rear and front panels, and the handle lays flush with the lid when the lid is closed. When the handle is used, it causes the rear panel to swing upwardly about the hinged connection between the rear edge of the rear panel and the rear edge of the frame, which in turn causes the rear edge of the front panel to also lift off the frame and rotate about the hinge between the rear and forward panels, thereby causing the front edge of the front panel to slide back towards the rear edge of the frame.

Preferably the frame includes a pair of rails, one on each side, and the corresponding left and right side of the front edge of the front panel is constrained to ride upon a respective rail when the lid is moved between its open and closed positions. When the lid is moved from open to closed, the flap and/or the front panel pushes any data and/or electrical cables that are not initially already located in the vicinity of the front edge of the frame, towards the front edge of the frame. When the lid is fully closed, the cables are retained between flap and the front edge of the frame.

Preferably a protrusion is included on each side of the lid in the vicinity of the leading edge of the lid. The protrusion runs along the inner edge of its adjacent rail, and when the lid is moved towards its closed position, the protrusions slide along the inner edge of their adjacent rails and collides with any cable(s) that are emerging from a side of the utility box, and as the lid continues to close, the protrusion forces the cable(s) towards the front edge of the frame.

Preferably each corner of the frame at the regions where the frame's front edge connects to its respective side of the frame includes a guide that co-operates with the pushing movement of the closing lid to direct the cables away from the corners and towards the middle portion of the front edge of the frame, thereby preventing the closing lid from jamming any cable into either corner of the frame.

Preferably the flap is configured so that it can lay flush with the lid when the lid is fully closed and there are no cables extending out of the utility box, and is able to sit at an appropriate angle, relative to the floor, to accommodate the width of the cables, when the lid is fully closed and there are cables are extending out of the utility box.

Optionally the end of at least one rail, in the vicinity of the front edge of the frame, includes a bevel that co-operates with the flap so that as the lid closes, the flap engages the bevel and the flap's leading edge is thereby forced to rise up at an angle relative to the plane of the floor to reduce the risk of any shearing action upon the cable(s) between the leading edge of the flap and the front edge of the frame, as the lid is closed.

Preferably the flap is made from an insulative pliant material such as rubber.

Preferably the front panel is wider than the rear panel so that as the lid is opened, the front panel forces the rear, panel to rotate about its hinged connection to the frame beyond 90° relative to the frame, so that when the lid is fully opened, the folded front and rear panels lean away from the opening of the utility box.

Preferably the lid is configured to self-close if the handle is released.

Optionally a detent is provided that releasably holds the open lid in the fully open position, even if the handle is released, and will release the lid so that it can self-close if the lid is bumped or kicked.

Optionally bias means, in the form of a suitable spring, are included that resist the overlaying of the front and rear panel as the lid is moved towards the fully opened position, and when the handle is released, the spring action is sufficient to force the front and rear panels apart a sufficient amount to at least initiate the self-closing action of the lid.

Optionally the detent is configured so that it automatically releases the lid so that it can self-close after a predetermined period of time.

Preferably the panels of the lid are formed out of suitably tough but non-electrically conductive material such as Acrylonitrile Butadiene Styrene (ABS) polymer.

Preferably each panel is able to, accommodate and retain a matching floor covering insert, such as carpet, so that when the lid is closed, the lid substantially blends into the surrounding floor covering.

Preferably the assembly can be retro-fitted to an existing floor mounted utility box installation.

In another form, the invention is a floor mounted utility box utilising a lid assembly of the type previously described wherein the interior of the utility box has at least one plate upon which connector means are mounted, and into which the ends of the data and/or electrical cables are connected. The at least one plate is angled so that the face bearing the connector means is more easily accessible from the opening created by the opening of the lid. The plate is located within the utility box in such a position that the volume and dimensions of the void created behind the plate and the walls of the utility box is sufficient to allow cable(s) with a large bending radius to be coiled within the said void.

In another aspect the invention consists of a utility box including:
a body of substantially rectangular shape,
an access hole,
a lid assembly,
a first mounting plate, and
a first void
   wherein the access hole is located on the top face of the box, and the lid assembly overlays the access hole when the box is in its normal use condition. The lid assembly is either removably or permanently attached to the body of the box, so that access to the interior of the box is gained when the access hole is no longer overlayed by the lid assembly. The box is substantially wider than the width of the access hole, and the first mounting plate is located inside the box either vertically or at an angle and is positioned at one side of the access hole along the longitudinal axis of the box. A variety of socket assemblies are mountable to the first mounting plate, and these socket assemblies comprise a faceplate that sits substantially on the front face of the first mounting plate. The space between the faceplate and the opposite end of the box has sufficient clearance to enable a wide selection of varying plug shapes and sizes. The socket assembly also may include a socket body that sits substantially on the rear face of the first mounting plate, and the first mounting plate and any attached socket body thereby creates a first void that is located between the rear of the first mounting plate and/or the rear of the socket body and the end of the box opposite the rear face of the first mounting plate. There is at least 100 mm of open distance between the rear face of the mounting plate or the rear of the socket body and the end of the box opposite the rear face of the first mounting plate.

The 100 mm of open distance can be measured linearly either along the floor of the box, or at an angle relative to the floor of the box.

The box may also include a second mounting panel located either vertically or at an angle inside the box on the opposite side of the hole, and its front face is facing the front face of the first mounting plate. A variety of socket assemblies are mountable to the second mounting plate, and these socket assemblies comprise a faceplate that sits substantially on the front face of the second mounting plate, thereby forming an opposing pair of socket faceplates. The space between the opposing pair of faceplates has sufficient clearance to enable a wide selection of varying plug shapes and sizes so that each can be simultaneously connectable to either of the opposing pair of faceplates. The socket assembly may also include a socket body that sits substantially on the rear face of the second mounting plate. The second mounting plate, and any attached socket body, thereby creates a second void that is located between the rear of the second mounting plate and/or the rear of the socket body and the end of the box opposite the rear face of the second mounting plate. There is at least 100 mm of open distance between the rear face of the second mounting plate or the rear of the socket body and the end of the box opposite the rear face of the second mounting plate.

Preferably the void(s) is/are at least capable of accommodating a coil of CAT6a or CAT7 data cable.

Preferably the mounting plate(s) are integrated into the body of the box, and the utility box is a floor box.

### BRIEF DESCRIPTION OF THE DRAWINGS

In order that the invention may be more fully understood there will now be described, by way of example only, preferred embodiments and other elements of the invention with reference to the accompanying drawings where:

FIG. 1 is an exploded view of the lid assembly.

FIG. 2 is a plan view of the lid assembly.

FIG. 3 is a sectional view of FIG. 2 taken through line B-B.

FIG. 4 is a sectional view of FIG. 2 taken through line A-A.

FIG. 5 is an isometric view of the present invention showing the lid in its open position.

FIG. 6 is an isometric view of the present invention showing the lid in its closed position.

FIG. 7 is an isometric view of another form of the invention where the flap is configured to sit at an angle relative to the frame.

FIG. 8 is a side view of the present invention with the lid in its open position.

FIG. 9 shows a top view of a utility box with the lid assembly.

FIG. 10 shows a sectional view of FIG. 1 taken through line A-A.

FIGS. 11 and 12 show an isometric view of a typical utility box installation with a coil of data cable.

### DESCRIPTION OF EXAMPLES OF THE INVENTION AND THE PREFERRED EMBODIMENT

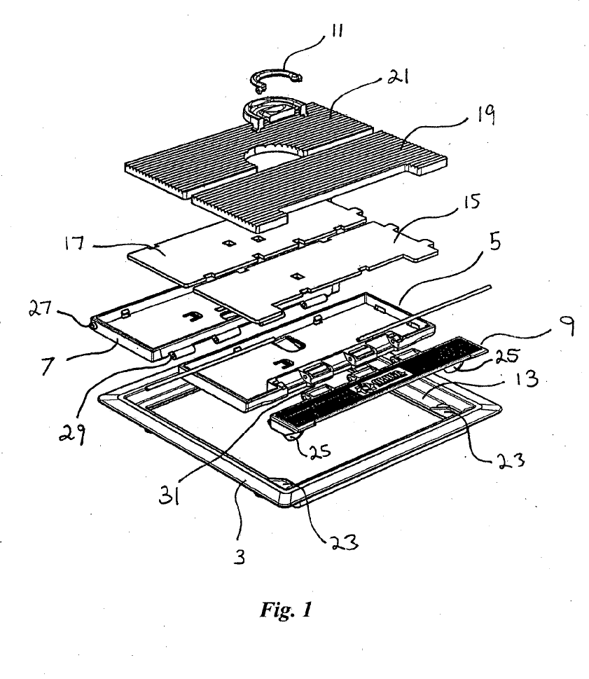

Referring to FIG. 1 we see an exploded view of the lid assembly. We can see the assembly includes a frame 3 and a bifold lid that includes a front panel 5 and a rear panel 7. A flap 9 is connected to the leading edge of the front panel 5 by flap hinge 31. The front and rear panels are connected together via bifold hinge 29. The rear edge of the rear panel 7 is connected to the rear edge of the frame 3 by rear hinge 27.

Optionally both the front panel 5 and the rear panel 7 may include a reinforcement panel 15 and 17 respectively. This is included to increase the load carrying capacity of the lid so it can withstand greater loads, including point loads that may be applied to it from a heel of a high heel shoe for example.

To make the lid aesthetically pleasing, optionally front panel 5 and the rear panel 7 is able to accommodate and retain a front panel floor covering insert 19 and a rear panel floor covering insert 21 respectively.

A handle 11 is provided to allow a user to lift the rear panel 7, thereby causing it to lift and rotate about the rear hinge 27. This in turn causes the rear edge of the front panel 5 to lift, and as it continues to lift, it drags the leading edge of the front panel 5 back towards the rear hinge 27. The leading edge of the front panel 5 is constrained to slide along a pair of rails 13 which are located one on each of the left and right hand sides of the frame. In FIG. 1, only the right hand side rail 13 is visible.

A flap 9 is connected to the leading edge of the front panel 56 via the flap hinge 31. The flap is made from a suitably pliant yet tough material. In this embodiment, the flap also includes a pair of protrusions 25 that slide along the inner edge of the left and right hand side rails 13. As the lid assembly is moved from it open to its closed positions, these protrusion collide with any cable(s) that may protrude out of the utility box form either the left or right hand side. As the lid continues to move towards its closed position, the cable(s) continue to be forced towards the front edge of the frame 3 by the protrusions 25.

Optionally the leading corners of the frame are fitted with a guide, and these cooperate with the action of the protrusions 25 to guide the cable(s) away from the corners, where they may become pinched between the lid and the frame.

Optionally the end of at least one rail 13 is fitted with a bevel 23 which is designed to ensure the flap is angled upwards, relative to the plane of the floor, to ensure there is no shearing force between the leading edge of the flap 9 and the frame 3 upon the cable(s) when the lid closes.

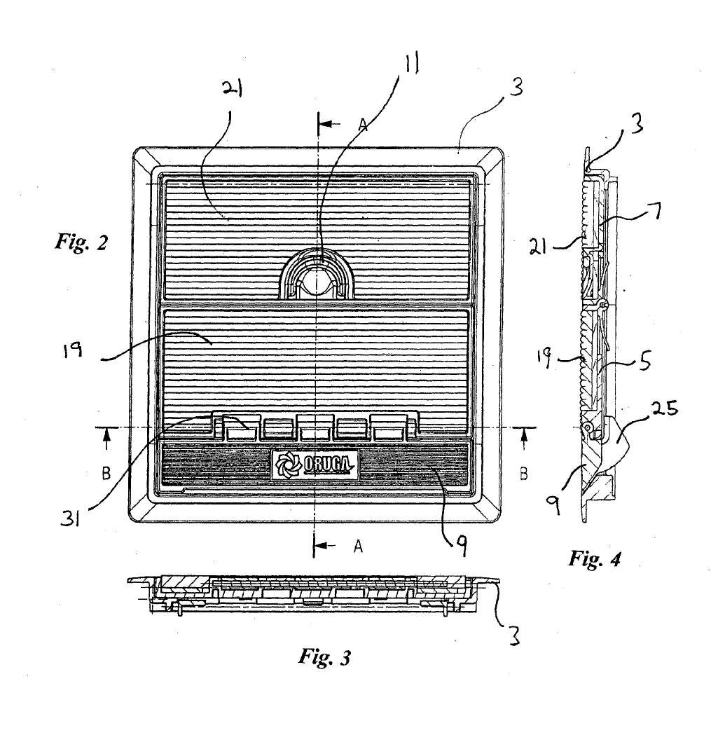

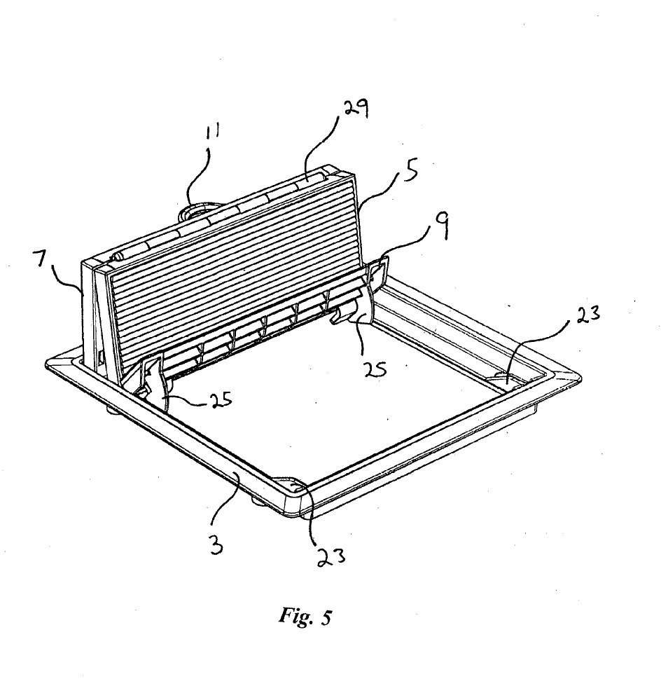

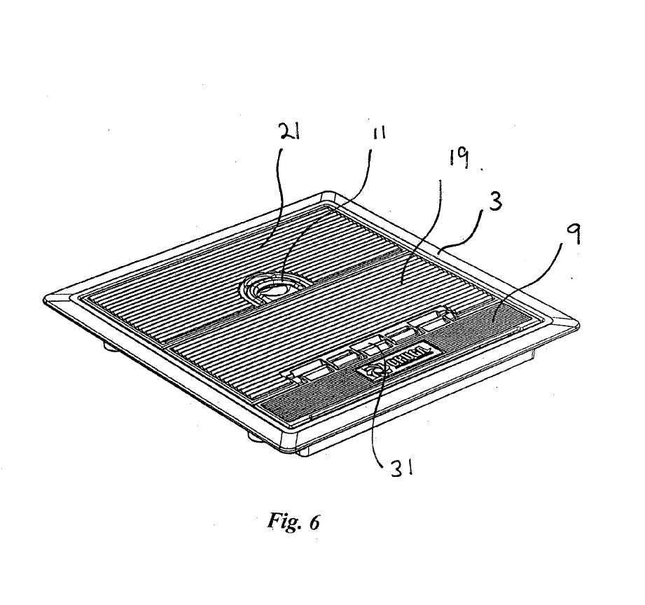

FIGS. 2, 3 and 4 show a plan view of the current invention in the fully closed position, and a pair of sectional views taken through lines A-A and B-B. In this embodiment, the flap 9 is configured to lay flat and flush when the lid is fully closed.

In a preferred embodiment, the flap 9 is made from a suitably tough and pliant material such as rubber that is capable of resisting any external loads applied to it such a people standing on it, but is also capable of yielding around the cable(s) to prevent them from being pinched or sheared between the leading edge of the flap 9 and the front edge of the frame 3. In yet another embodiment, the flap is made of metal such as aluminium.

Turning to FIG. 5 we see an isometric view of the invention with the lid in the fully to open position. The lid is configured so that it will self-close if the user releases the handle 11. Optionally a detent (not shown) is included that is capable of holding the lid in the fully open position when the handle 11 is released. The detent is configured so that if the open lid is either bumped or kicked, the detent releases the lid, and the lid self closes. In another embodiment, the detent may include a timing mechanism that only allows the detent to hold the lid open for a set period of time, after which the detent releases automatically and the lid is then able to self-close. This reduces trip hazards caused by open lids and open utility boxes. If the user accidently leaves the lid open, the lid self closes if it is accidently bumped, or kicked, or if a set time has expired.

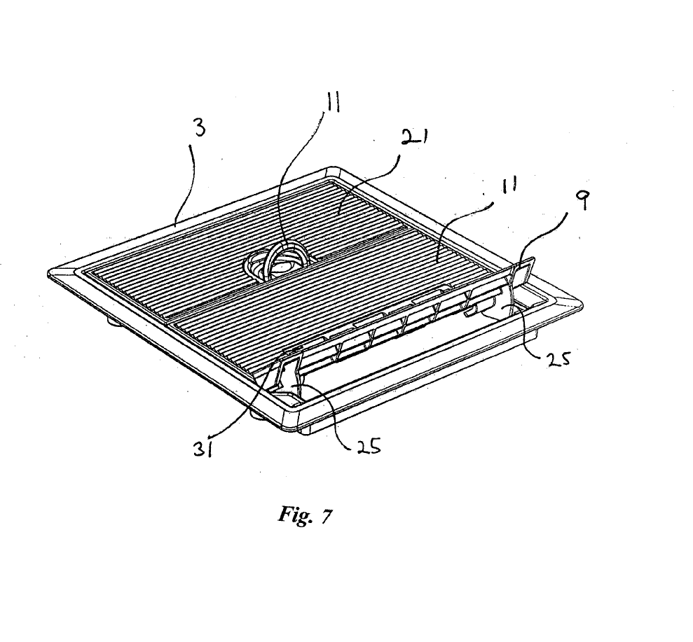

FIG. 6 shows an isometric view of the lid assembly with the form of the invention where the flap 9 remains flush with the lid when the lid is fully closed. FIG. 7 shows an alternative embodiment where the flap is configured to sit at an angle, relative to the plane of the floor. In this configuration, the leading edge of the flap 9 is not able to apply a shearing force to any cable(s) extending out of the utility box as the lid closes.

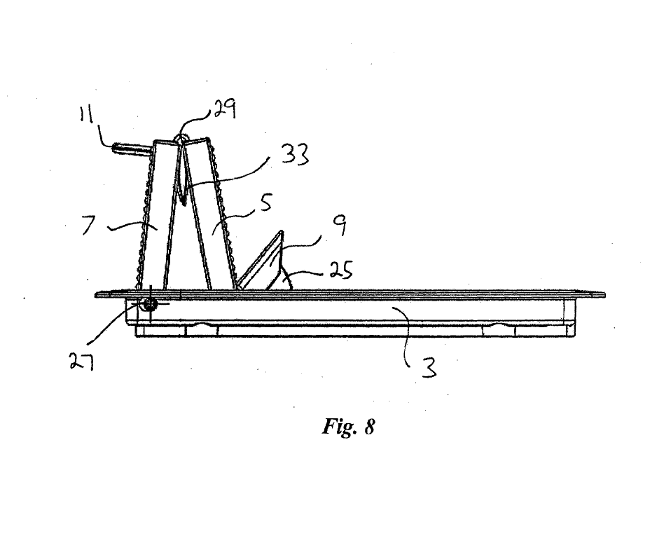

Turning to FIG. 8, we can see in the side view that in this particular embodiment, biasing means in the form of spring 33 is included. These biasing means resist the overlaying of the front panel 5 and the rear panel 7. When the handle 11 is released, the biasing means may at least initiate the closing of the lid, and once the lid closes a certain amount, gravity takes over to close the lid the rest of the way.

In yet another embodiment, not shown in the figures, the front plate 5 is wider than the rear plate 7. This means that as a user lifts handle 11, the wider front plate 5 forces the rear plate 7 to rotate to an angle greater than 90°, and this means that when the lid assembly is fully opened, the overlaying first and second panels are at an angle greater than 90° to the plane of the lid. This moves the lid assembly further out of the way, with respect to the utility box, when it is fully open.

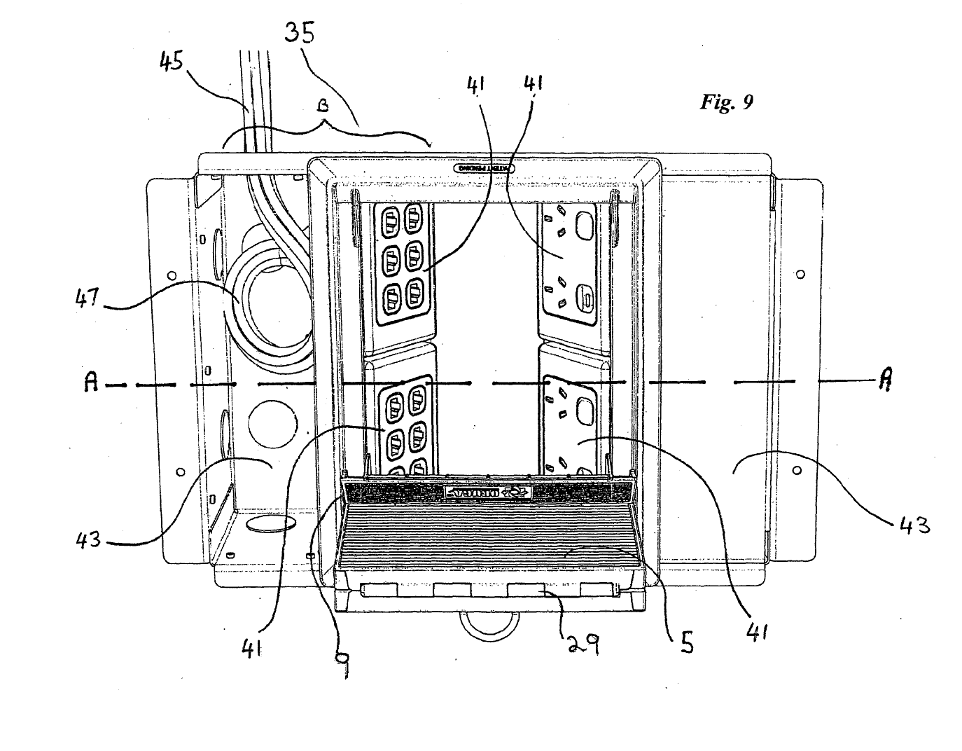

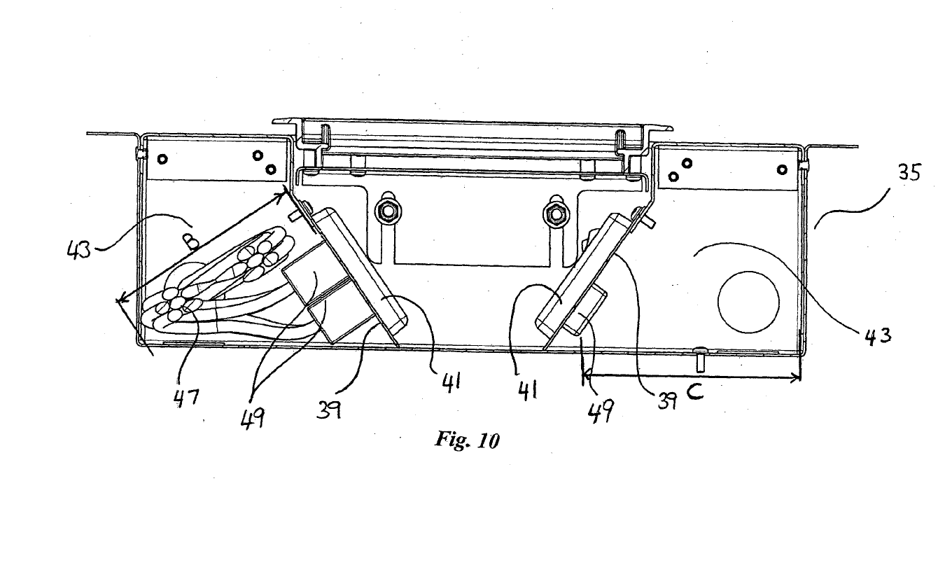

FIG. 9 shows a floor mounted utility box using a lid as previously described. In this to view we see a top view of a floor mounted utility box 35. The lid 37 is in a retracted position so that a user has access to the interior of the utility box 35. Inside the box we can see two mounting plates 39 (see FIG. 10).

Each mounting plate has a pair of socket faceplates 41 for the connection of various power and data connectors. In this embodiment, each of the mounting plates 5 are angled with respect to each other as shown, so that the user has easier access to the various power or data sockets carried on the socket faceplates 41. A void 43 is created in between the rear of each mounting panel 39 and its respective end of the utility box 35. In this view, you can see some data cable 45 entering the utility box 35 from the top left. The cable is formed into a cable coil 47 inside the void 43. The distance across the floor of the box as shown by the parenthesis labeled B that correlates with the distance measured from the bottom of the mounting plate 39 to its corresponding end of the utility box 35, is at least 100 mm. This gives the void 43 sufficient space in order to accommodate a data or other utility cable with relatively large bending radius such as CAT 6 type data cable.

Turning to FIG. 10 we are shown a cut-away view of the utility box 35 through line A-A as shown on FIG. 9. Again we can see a pair of angled mounting plates 39 that line up on opposite sides of the opening typically covered by the lid (not shown). In this view, we can see the socket body 49 that sits immediately behind the mounting plate 39. In some cases, the size of the socket body 49 may be substantial, and therefore the void 43 may be defined as the space between the rear of the socket body 49 and the end of the box opposite the rear face of the mounting panel to which the socket body is mounted upon. The distance indicated by arrow B, and measured at an angle relative to the floor of the box, is at least 100 mm. Since the socket body 49 attached to the mounting plate 5 near the arrow C is comparatively small, the distance indicated by arrow C is also a minimum of 100 mm, when measured linearly along the floor of the box.

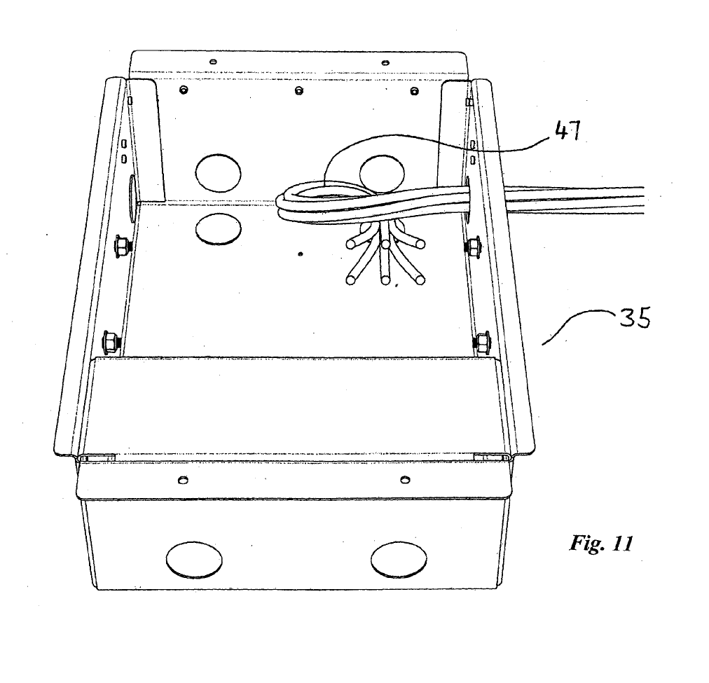

Turning to FIG. 11, we are shown a floor box in accordance with the present invention, where the mounting panel is removed to show the orientation of the cabling that sits behind it and is connectable to the socket body 49 (not shown).

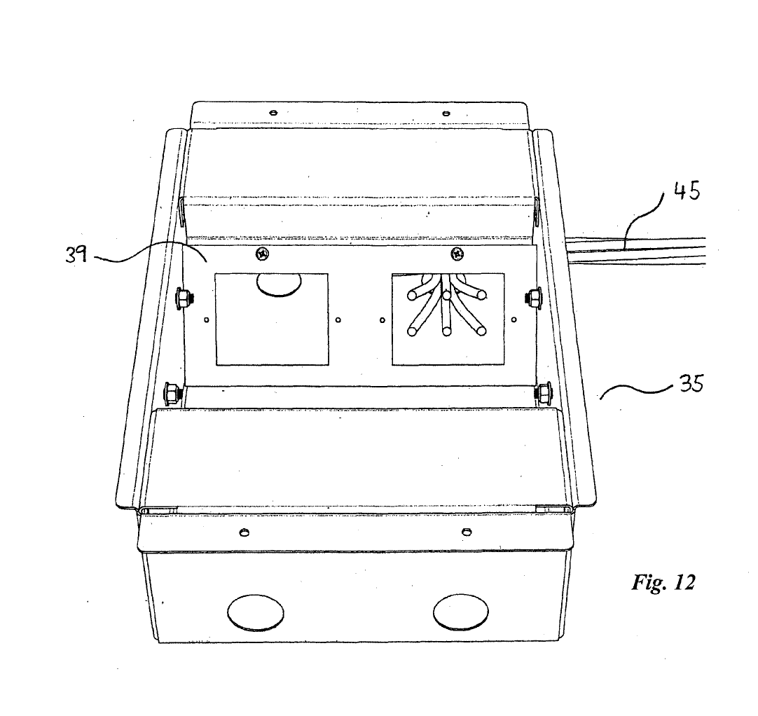

Finally in FIG. 12 we see that the mounting plate 39 is shown, and the data cable 45 is shown how it is orientated with respect to the mounting panel.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A lid assembly for a floor mounted utility box of the type allowing the connection of a variety of data and or electrical cables that when connected, extend out of the utility box, the said lid assembly including:
a frame,
a lid, and
a flap,
wherein the frame is mounted upon the utility box and when it is mounted, it lies substantially flush with the level of the floor, and wherein the said lid includes a rear panel and a front panel that are hingedly connected to each other, and the rear edge of the rear panel is hingedly connected to the rear edge of the said frame, and wherein the said flap is hingedly connected to the forward edge of the front panel, so that when the lid is closed, at least the rear panel and the front panel lay flat and substantially flush with the level of the floor, and when the lid is opened, the lid bifolds about the hinged connection between the rear and front panels, causing the forward edge of the front panel to slide towards the rear edge of the frame, so that when the lid is moved to its fully opened position, the rear and front panels substantially overlay one another in the vicinity of the rear of the frame.

2. The lid assembly as claimed in claim 1 wherein the rear panel includes a handle that is located in the vicinity of the hinge between the rear and front panels, and the said handle lays flush with the lid when the lid is closed, and when the handle is used, it causes the rear panel to swing upwardly about the hinged connection between the rear edge of the rear panel and the rear edge of the frame, which in turn causes the rear edge of the front panel to also lift off the frame and rotate about the hinge between the rear and forward panels, thereby causing the front edge of the front panel to slide back towards the rear edge of the frame.

3. The lid assembly as claimed in claim 2 wherein the frame includes a pair of rails, one on each side, and the left and right side of the front edge of the front panel is constrained to ride upon a respective rail when the lid is moved between its open and closed positions, and when the lid is moved from open to closed, the flap and/or the front panel pushes any data and/or electrical cables, that are not initially already located in the vicinity of the front edge of the frame, towards the front edge of the frame, and when the lid is fully closed, the cables are retained between flap and the front edge of the frame.

4. The lid assembly as claimed in claim 3 wherein a protrusion is included on each side of the lid in the vicinity of the leading edge of the lid, and the said protrusion runs along the inner edge of its adjacent rail, and when the lid is moved towards o its closed position, the protrusions slide along the inner edge of their adjacent rails and collides with any cable(s) that are emerging from a side of the utility box, and as the lid continues to close, the protrusion forces the cable(s) towards the front edge of the frame.

5. The lid assembly as claimed in claim 4 wherein each corner of the frame at the regions where the frame's front edge connects to its respective side of the frame includes a guide that co-operates with the pushing movement of the closing lid to direct the cables away from the corners and towards the middle portion of the front edge of the frame, thereby preventing the closing lid from jamming any cable into either corner of the frame.

6. The lid assembly as claimed in claim 5 wherein the flap is configured so that it can lay flush with the lid when the lid is fully closed and there are no cables extending out of the utility box, and is able to sit at an appropriate angle, relative to the floor, to accommodate the width of the cables, when the lid is fully closed and there are cables are extending out of the utility box.

7. The lid assembly as claimed in claim 5 wherein the end of at least one rail, in the vicinity of the front edge of the frame, includes a bevel that co-operates with the flap so that as the lid closes, the flap engages the bevel and the flap's leading edge is thereby forced to rise up at an angle relative to the plane of the floor to reduce the risk of an shearing action upon the cable(s) between the leading edge of the flap and the front edge of the frame, as the lid is closed.

8. The lid assembly as claimed in claim 7 wherein the flap is made from an insulative pliant material such as rubber.

9. The lid assembly as claimed in claim 8 wherein the front panel is wider than the rear panel so that as the lid is opened, the front panel forces the rear panel to rotate about its hinged connection to the frame beyond 90° relative to the frame, so that when the lid is fully opened, the folded front and rear panels lean away from the opening of the utility box.

10. The lid assembly as claimed in claim 8 wherein the lid is configured to self-close if the handle is released.

11. The lid assembly as claimed in claim 10 wherein a detent is provided that releasably holds the open lid in the fully open position, even if the handle is released, and will release “the lid so that it can self-close if the lid is bumped or kicked.

12. The lid assembly as claimed in claim 11 wherein bias means, in the form of a suitable spring, are included that resist the overlaying of the front and rear panel as the lid is moved towards the fully opened position, and when the handle is released, the spring action is sufficient to force the front and rear panels apart a sufficient amount to at least initiate the self-closing action of the lid.

13. The lid assembly as claimed in claim 12 wherein the detent is configured so that it automatically releases the lid so that it can self-close after a predetermined period of time.

14. The lid assembly as claimed in claimed in claim 12 wherein the panels of the lid are formed out of suitably tough but non-electrically conductive material such as Acrylonitrile Butadiene Styrene (ABS) polymer.

15. The lid assembly as claimed in claim 14 wherein each panel is able to accommodate and retain a matching floor covering insert, such as carpet, so that when the lid is closed, the lid substantially blends into the surrounding floor covering.

16. The lid assembly as claimed in claim 15 wherein the assembly can be retro-fitted to an existing floor mounted utility box installation.

17. A floor mounted utility box utilising a lid of the type previously claimed wherein the interior of the utility box has at least one plate upon which connector means are mounted, and into which the ends of the data and/or electrical cables are connected, and the at least one plate is angled so that the face bearing the connector means is more easily accessible from the opening created by the opening of the lid, and the plate is located within the utility box in such a position that the volume and dimensions of the void created behind the plate and its respective outer wall of the utility box, is sufficient to allow cable(s) with a large bending radius to be coiled within the said void.
